(19) United States
(12) Patent Application Publication
(10) Pub. No.: US 2014/0058615 A1
(43) Pub. Date: Feb. 27, 2014

(54) FLEET ANOMALY DETECTION SYSTEM AND METHOD

(71) Applicants: Charles Terrance Hatch, Gardnerville, NV (US); Adam Anthony Weiss, Minden, NV (US); Steven Ross Hadley, Sunol, CA (US)

(72) Inventors: Charles Terrance Hatch, Gardnerville, NV (US); Adam Anthony Weiss, Minden, NV (US); Steven Ross Hadley, Sunol, CA (US)

(21) Appl. No.: 13/590,974

(22) Filed: Aug. 21, 2012

(51) Int. Cl. G06F 11/30

(52) U.S. Cl. 701/29.3

(57) ABSTRACT

Systems and methods for detecting anomalous behavior in one of a fleet of machines are provided. Data regarding a single characteristic representative of operation of the mechanical system is collected from each machine in a fleet. The systems and methods are configured for processing of the data to determine and indicate when significant deviations from normal operating conditions are occurring that represent the departure from normal operation condition by one or more of the machines in the fleet.

### BACKGROUND OF THE INVENTION

The present invention relates generally to systems and methods for monitoring machinery or other mechanical devices during operation, and more specifically, to systems and methods for monitoring fleets of machinery or other mechanical devices that contain at least some identical components during operation, to detect possible operational issues including impending maintenance and failure situations.

Mechanical devices, particularly mechanical devices that incorporate rotating machinery, typically exhibit characteristic movements during operation, such as vibrations, that have frequencies and/or magnitudes that vary according to the operating speeds and conditions of the rotating machinery. An operating status of the vibration spectra of an operating machine is typically monitored, e.g., through the use of transducers, to confirm satisfactory steady state operation of the machine, and to identify when the machine may require maintenance or whether a failure event may be imminent. A machine, such as a wind turbine used for power generation, may have more than one hundred different vibrational characteristics, variations in which may indicate deviations from normal operational conditions, representing wear beyond accepted norms, or impending failure.

However, even identical machines can have distinctive characteristic “signatures” (features) with respect to both normal operation and failure modes. As such, one or more machines, in a fleet of similarly configured machines that are being monitored, may develop a mechanical or an electrical issue that causes the measurements from that machine or machines to deviate significantly from those of the rest of the fleet, assuming the rest of the fleet is operating normally. Alternatively, if during installation of a particular machine, the initial operating parameters were not correctly established (e.g., monitoring software installed on an initially defective machine), then the baseline parameters for that machine would have been determined incorrectly at the time of initial installation and setup.

It would be desirable, when implementing monitoring systems for operating machinery, in particular a fleet of similar machines, to set up monitoring and alarm systems that are sensitive and discriminating enough to identify and/or ignore random outlier events that would otherwise quantify, due to their deviation from normal operational values, as representing maintenance or failure mode operations. At the same time, it would be desirable, when implementing systems for operating machinery, to set up monitoring and alarm systems that are sufficiently reliable and robust to avoid excessive false alarm events.

When seeking to obtain the foregoing desired results, the challenge typically lies not with the physical equipment used to detect and monitor the operating machinery, but in appropriately processing and interpreting the data acquired as a result of the monitoring of the operating machinery. If the detected deviation from normal operation parameters required for an alarm event is set too low, the risk for false alarms is increased; if the detected deviation from normal operating parameters required for an alarm event is set too high, the risk of delayed or missed alarm, leading to potential damage to the machinery in question, is increased. In addition, while conventional statistical methods may be used for anomaly detection, such methods can often require large sample sizes with substantial amounts of data, to enable the analysis to be robust enough to protect against false and missed alarm events. In addition, such methods can also still be susceptible to influence by normally-distributed outliers in the data.

It would be desirable to provide a method and system for detection of anomalies in the operation of a fleet of machines, while protecting against false or missed alarm events, while obviating the need for overly-large sample data sets.

### BRIEF DESCRIPTION OF THE INVENTION

In an aspect, a system for use in detecting anomalous behavior in at least one of a fleet of machines is provided, wherein each of the machines includes at least one component in common with all other machines in the fleet. The system includes: a plurality of sensors, at least one of the plurality of sensors coupled to each machine in the fleet; and a control system. The control system is configured to receive data transmitted from the plurality of sensors during operation of the fleet of machines, wherein the data is representative of at least one operating characteristic of the at least one component. The control system is further configured to collect data representative of the operating characteristic from each of the machines in the fleet, wherein the data is collected under similar operating conditions for each machine. The control system is further configured to calculate a set of mean values from the operating characteristics of each of the machines in the fleet. The control system is further configured to calculate a set of deviations corresponding to the set of mean values relative to a median value of the set of mean values. The control system is further configured to determine if anomalous behavior exists based on the set of deviations.

In another aspect, a method for use in detecting anomalous behavior in at least one of a fleet of machines is provided, wherein each of the machines includes at least one component in common with all other machines in the fleet. The method includes coupling at least one of a plurality of sensors to each machine in the fleet, wherein each sensor is configured to: detect at least one operating characteristic of the at least one component; and transmit data representative of the detected characteristic to a control system. The method further includes collecting data representative of the detected characteristic from each of the machines in the fleet, wherein the data is collected under similar operating conditions for each machine. The method further includes calculating a set of mean values from the detected characteristics of each of the machines in the fleet. The method further includes calculating a set of deviations corresponding to the set of mean values relative to a median value of the set of mean values. The method further includes determining if anomalous behavior exists based on the set of deviations.

### BRIEF DESCRIPTION OF THE DRAWINGS

FIG. 1 is a schematic illustration of an exemplary measurement system that may be used for automatic fleet anomaly detection.

FIG. 2 is a flowchart illustrating an exemplary method for automatic fleet anomaly detection.

FIG. 3 is an exemplary plot illustrating sensed vibrations for a fleet of machines, and featuring an output indicating an undetected defective machine.

FIG. 4 is an exemplary plot illustrating sensed vibrations for a fleet of machines, and featuring an output indicating a detected defective machine.

FIG. 5 is another exemplary plot illustrating sensed vibrations for a fleet of machines, and featuring an output indicating an undetected defective machine.

### DETAILED DESCRIPTION OF THE INVENTION

Although specific features of various embodiments of the invention may be shown in some drawings and not in others, this is for convenience only. In accordance with the principles of the invention, any feature of a drawing may be referenced and/or claimed in combination with any feature of any other drawing.

A technical effect of the systems and methods described herein includes at least one of: (a) coupling at least one of a plurality of sensors to each machine in a fleet of machines, wherein each of the machines includes at least one component in common with all other machines in the fleet; (b) configuring each sensor to detect at least one operating characteristic of the at least one component; (c) transmitting data representative of the detected characteristic from the sensors to a control system; (d) collecting data representative of the detected characteristic from each of the machines in the fleet, wherein the data is collected under similar operating conditions for each machine; (e) calculating a set of mean values from the detected characteristics of each of the machines in the fleet; (f) calculating a set of deviations corresponding to the set of mean values relative to a median value of the set of mean values; (g) determining if anomalous behavior exists based on the set of deviations; (h) calculating a characteristic value representative of the set of deviations; (i) calculating a set of normalized deviations for the calculated characteristic value for each of the machines in the fleet; and (j) comparing the set of normalized deviations to a predefined threshold.

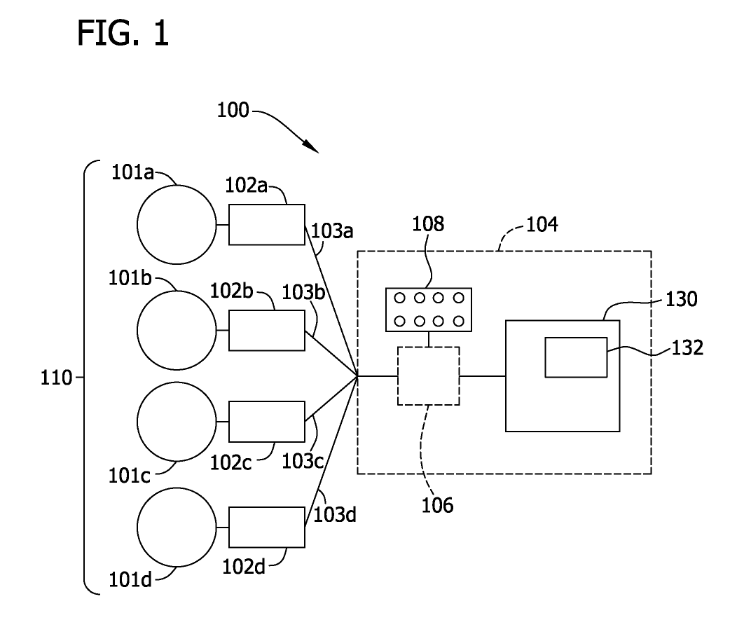

FIG. 1 is a schematic illustration of an exemplary measurement system 100 that includes a display 130 that may be used to monitor a fleet 110 of machines 101a, 101b, 101c, 101d, etc. Display 130 may be incorporated into an overall equipment control system, wherein the term “equipment control system” should be understood to include not only systems that actually regulate the operation of devices or machinery, but also systems such as monitoring or measurement systems, such as the measurement system 100.

For example, measurement system 100 for fleet 110 may include one or more sensors 102a, 102b, 102c, 102d, etc., such as vibration transducers, each of which is connected to a component of an apparatus 101a, 101b, 101c, 101d, etc., being tested, such as a shaft or mounting structure of a rotary machine, and/or a wind turbine used for power generation, for example, that are likewise connected to a display system 104 that supports and provides a display 130. Display system 104 may include one or more processors 106 that receive, via connections 103a, 103b, 103c, 103d, etc., (which may be any suitable medium, whether hard-wired or wireless), raw signal(s) (not shown) transmitted from sensor(s) 102a, 102b, 102c, 102d, etc. In the exemplary embodiment, control panel 108 enables a user to selectively configure the image 132 being shown on, e.g., display 130, and select which numerical values processor(s) 106 derive from the raw signal(s) being transmitted from sensor(s) 102a, 102b, 102c, 102d, etc. Display system 104 may, for example, be a suitably programmed desktop or laptop computer, in which the internal processors of the desktop or laptop computer serve as processor(s) 106, its keyboard functions as control panel 108 and the screen of the desktop or laptop computer will show display 130.

As used herein, the term processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Sensors 102a, 102b, 102c, 102d, etc. (such as vibration transducers) will indicate vibration in the form of an analog waveform, and a determination of the amount of vibration may be represented by a calculation based on the waveform, such as peak-to-peak distance, and/or peak amplitude. After collecting data from each apparatus 101a, 101b, 101c, 101d, etc., appropriately configured software may be used to acquire data during a preliminary operation phase of the exemplary method for use in developing a set of baseline data representative of normal performance for each apparatus 101a, 101b, 101c, etc.

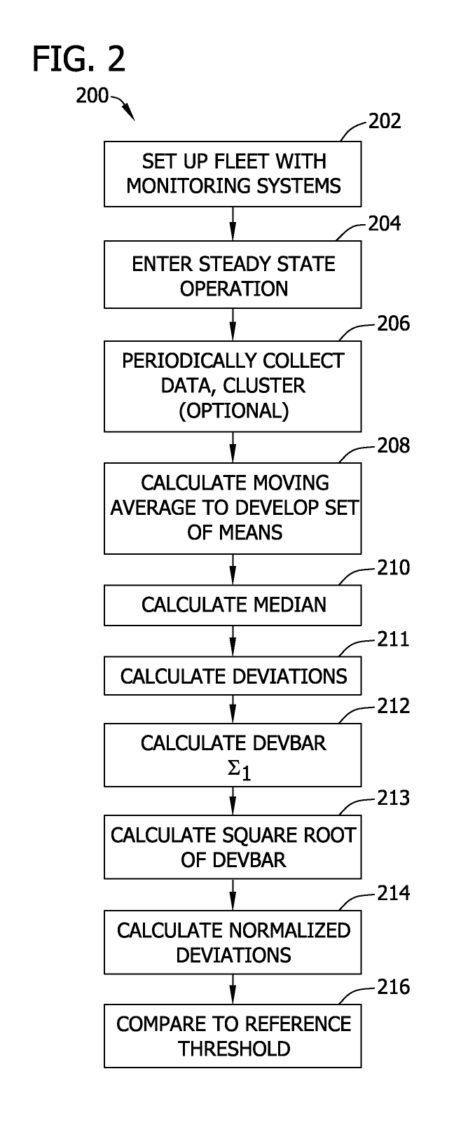

FIG. 2 is a flowchart illustrating an exemplary method 200 that may be used to detect anomalous behavior in one of a fleet 110 of machines or machine systems 101a, 101b, 101c, 101d, etc., having at least one functional component 105a, 105b, 105c, 105d, etc., in common. Method 200 may be implemented using system 100 (shown in FIG. 1). Accordingly, in the exemplary embodiment, initially a fleet of apparatus 101a, 101b, 101c, 101d, etc., is established 202, each of which apparatus includes suitable monitoring sensor(s) 102a, 102b, 102c, 102d, etc. The sensors 102a, 102b, 102c, 102d, etc., transmit raw signals via connections 103a, 103b, 103c, etc., to processor 106.

After establishment 202 of fleet 110, system 100, including processor 106 (shown in FIG. 1), enters 204 steady state operation and acquires 206 operating data representative of at least one characteristic common to each apparatus 101a, 101b, 101c, 101d, etc. The data optionally can be clustered 206 according to the operating conditions (e.g., heavy load vs. light load), or by any other category or combination of categories relevant to the particular application. Sampling for data collection occurs periodically. As used herein, the term “sample” is defined as data collected during a sample collection session over a previously-defined period of time. The time period for a sample collection session may be extremely short (i.e., measurable in milliseconds), or relatively long by comparison (i.e., measurable in minutes, hours, days, etc.), depending upon the type of phenomenon being monitored. The sample collection sessions will generally occur at pre-defined periods of time, such as every thirty (30) minutes, or any other period of time.

During normal operation, measurement system 100 collects data 206 from each apparatus 101a, 101b, 101c, 101d, etc., in fleet 110, regarding the parameter of interest, and calculates 208 a moving average for the parameter of interest. As used herein, the moving average is a continuous recalculation of a numerical value, based on data acquired during a moving defined period of time. In one embodiment, system 100 uses a moving window (buffer) of data comprising thirty (30) samples, for each machine/apparatus, though the window size may be selectively configured by an operator of system 100 to be more or less than thirty (30) samples, depending upon the particulars of the apparatus 101a, 101b, 101c, 101d, etc. being monitored.

Data collection 206 may occur simultaneously for all machines 101a, 101b, 101c, 101d, etc., in a fleet, provided that all machines are operating under similar conditions. That is, in the exemplary embodiment, data collection 206 occurs continuously at periodic intervals as described herein, and samples from the collected data for analysis purposes are taken for various machines at the time periods during which similar operating conditions are in effect. Accordingly, for a given operating condition (e.g., low wind conditions), data for machine 101a may be sampled at one time period, while data for the same operating condition for machine 101b may be taken at an earlier or later time period.

As described above, a simple moving average for the parameter of interest is obtained from each apparatus 101a, 101b, 101c, 101d, etc. This forms a set of means, xᵢ, wherein i=1, 2, 3, n of the measurement of the particular parameter for each one of the set of apparatus 101a, 101b, 101c, etc.

After the set of means has been calculated 208 for each machine/apparatus, system 100 then calculates 210, for each machine/apparatus, the median value of the set of i means, xᵢ and then calculates 211 the set of deviations of each member of the set of the means relative to the median:

deviationᵢ=(xᵢ−median).

Taking the absolute values of the set of deviations, system 100 then calculates 212 the simple average of the absolute values, devbar, using n−1, wherein n is the number of measurements (number of samples) in the set of means. Thus,

devbar=sum(abs(deviationᵢ))/(n−1).

System 100 then calculates 213, for each machine/apparatus of fleet 110, sigma1 (or “Σ1”)=sqrt (devbar), wherein “sqrt” is the square root function. System 100 then calculates 214 a set of normalized deviations zᵢ, where

zᵢ=(xᵢ−median)/sigma1

System 100 then applies 216 a constant, nsigma (nΣ). In an exemplary embodiment, nΣ=1.5, though a greater or lesser value for nΣ may be applied, as appropriate for the particular application. If system 100 calculates zᵢ such that

zᵢ>nΣ,

then an anomaly exists. As described above, in the exemplary system, analysis is performed using devbar, which is defined as a simple average of the absolute values of the deviations. However, other exemplary systems may employ other calculated characteristic values representative of the set of deviations for the detected characteristic or feature of the waveforms indicated by sensors 102a, 102b, 102c, 102d, etc.

Accordingly, for each machine/apparatus for which the above-identified numerical relationship is true, that respective machine/apparatus is identified as officially “defective” requiring human operator intervention to determine whether maintenance, repair or replacement of some or all of the components 105 or other components (not shown) is indicated.

System 100 as described herein advantageously calculates deviations relative to a median value with respect to a set of measurements corresponding to a specific parameter, instead of the mean of the set of measurements. This reduces the effect of outlier measurements on the central value (the middle value of the set of measurements). It is desirable to have the central value represent an average of normally distributed data points that does not include outlier data points that may not be part of the distribution corresponding to normal behavior. This is believed to be better estimated by the median of the set. System 100 further advantageously uses the square root of the average absolute deviation from the median to reduce the influence of outliers (anomalies) on Σ1, which serves as a proxy for the standard deviation typically used in statistical analyses employed in evaluating machinery performance. Typical standard deviation calculation involves the use of a root mean square calculation that tends to emphasize the effect of outliers. By using a square root calculation, the proxy is reduced, which tends to increase the sensitivity of the exemplary method to outliers. Also, the method allows use of a relatively small set of data (on the order of ten samples or less) compared to typical statistical methods that require a much larger set (typically 30 or more) to generate valid statistics. This allows application of the method to a relatively small fleet of machines.

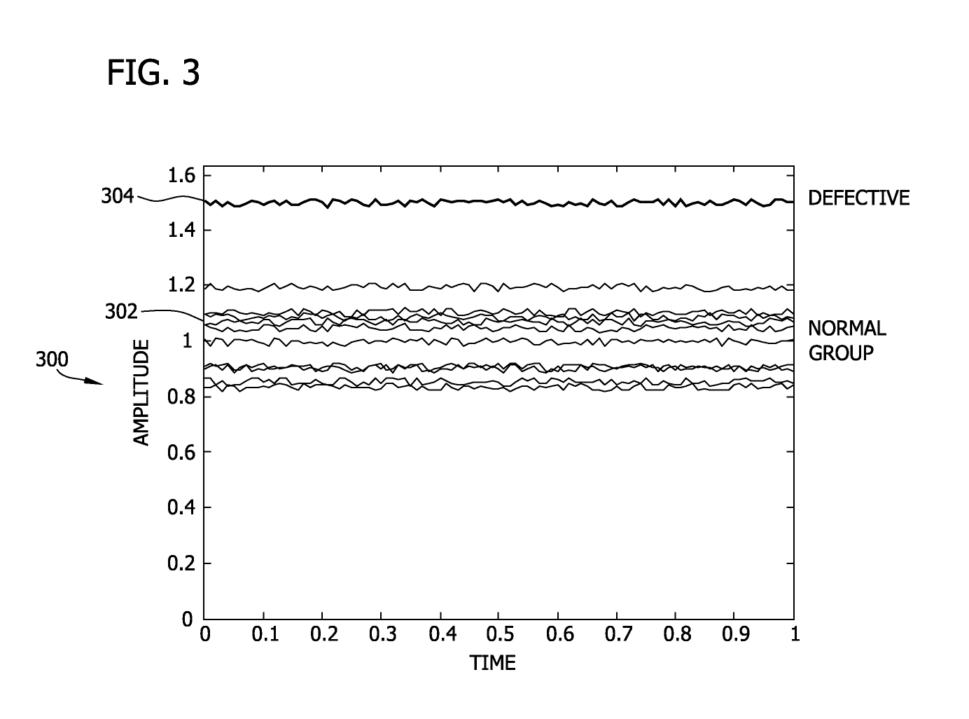

The systems and methods described herein facilitate identifying an outlier (i.e., defective) apparatus in a manner that can be supported by visual examination of plots of the collected and processed data. In any fleet of normally distributed measurements (samples) taken from a fleet of normally distributed machines, an amount of variation in measurement of the selected characteristic is anticipated. In addition, in any measurement system, an amount of random noise is anticipated, which may further contribute to variations in measurement. The effects of these considerations are illustrated in FIGS. 3-5 described hereinafter. Each plot features a simulated potentially defective machine amongst a group of normally operating machines.

FIG. 3 is an exemplary plot 300 illustrating simulated sensed vibrations for a fleet of machines, showing an output 302 indicating normally operating machines, and further showing an output 304 indicating an undetected defective machine. In exemplary plot 300, output 304 of the defective machine is not well-separated from output 302 indicating the normally operating machines. Visual inspection does not confirm with reasonable certainty that the defective machine is functioning in a significantly different manner than that of the group of normally operating machines.

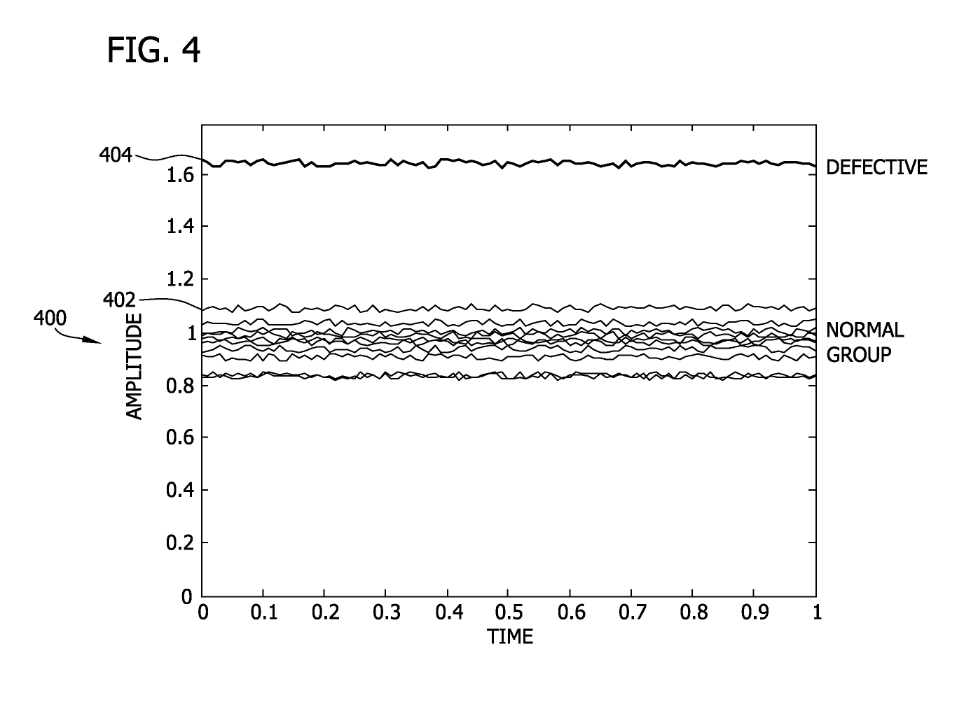

FIG. 4 is an exemplary plot 400 illustrating a simulated output 402 indicating a group of normally operating machines and further illustrating a simulated output 404 indicating a detected defective machine. In exemplary plot 400, the output 404 of the defective machine is well-separated from the output 402 representing the group of normally operating machines. Further, visual inspection confirms with reasonable certainty that the defective machine is operating in a significantly different manner than that of the group of normally operating machines.

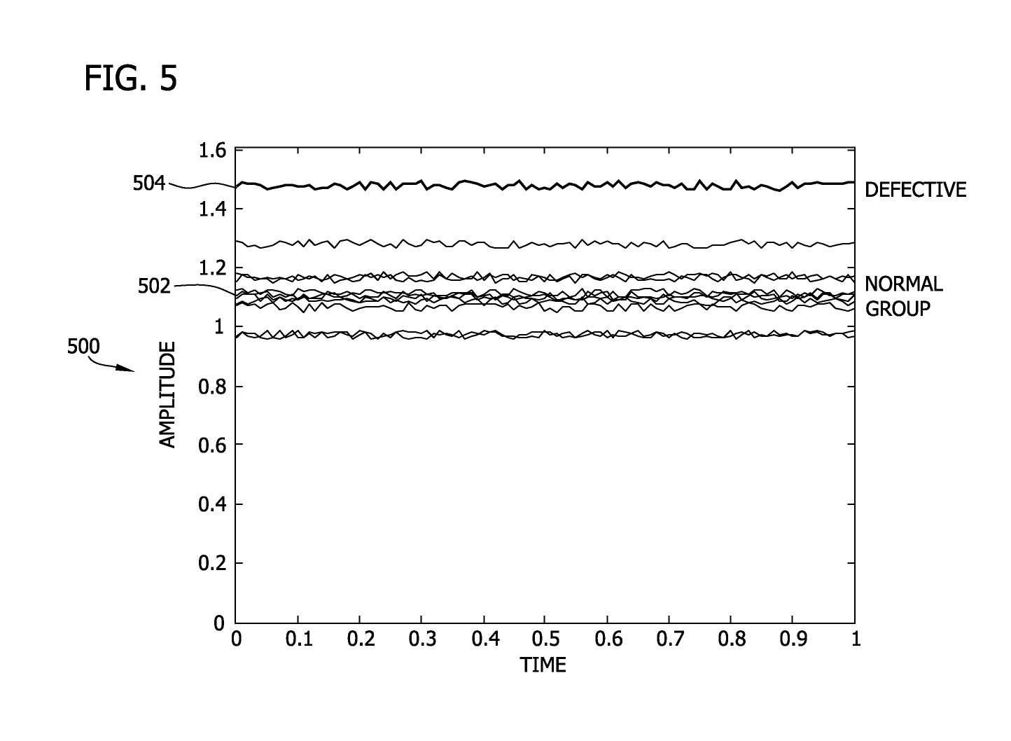

FIG. 5 is an exemplary plot 400 illustrating a simulated output 502 indicating a group of normally operating machines and further illustrating a simulated output 504 indicating an undetected defective machine. In exemplary plot 500, the output 504 of the defective machine is nearly indistinguishable from the output 502 from the group of normally operating machines. Further, visual inspection does not clearly confirm that the defective machine is operating in a significantly different manner than that of the group of normally operating machines.

Accordingly, application of the systems and methods herein operates on the measurements taken, and either detects anomalous behavior or fails to detect anomalous behavior. However, visual detection of the plots generated can provide a backup verification of a positive detection of an anomaly (such as in a close case), or overturn a false positive detection of an anomaly. Failure of the systems and methods described herein to detect an anomaly does not equate to a failure of the systems and methods, in that the systems and methods herein are configured for detection when visual examination is capable of supporting the result arising from application of the systems and methods described herein. Doing so achieves the result of avoiding apparent (and real) false alarms that may cause an operator of the fleet of machines to lose confidence in the systems and methods used.

The systems and methods described herein enable the detection of anomalous behavior in one or more machines from a fleet of machines having at least one operating component in common. The systems and methods described herein provide for the reliable detection of such anomalous behavior so that machinery operators can be alerted to such conditions, and intervene as appropriate, while avoiding false alarms. In addition, the systems and methods described herein can address situations such as when learning and change detection programming is installed on defective machinery, thus making the learned measurement levels inaccurate and not useful for detecting changes in operation of the machine. The systems and methods described herein further enable the detection of anomalous behavior in one or more of a fleet of machines without consumption of large quantities of data, or the requirement for a learning phase prior to initiation of steady state operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for use in detecting anomalous behavior in at least one of a fleet of machines, wherein each of the machines includes at least one component in common with all other machines in the fleet, said system comprising:
a plurality of sensors, at least one of said plurality of sensors coupled to each machine in the fleet; and
a control system configured to:
receive data transmitted from said plurality of sensors during operation of the fleet of machines, wherein the data is representative of at least one operating characteristic of the at least one component;
collect data representative of the operating characteristic from each of the machines in the fleet, wherein the data is collected under similar operating conditions for each machine;
calculate a set of mean values from the operating characteristics of each of the machines in the fleet;
calculate a set of deviations corresponding to the set of mean values relative to a median value of the set of mean values; and
determine if anomalous behavior exists based on the set of deviations.

2. A system in accordance with claim 1 wherein said control system is further configured to:
calculate a characteristic value representative of the set of deviations; and
calculate a set of normalized deviations for the calculated characteristic value for each of the machines in the fleet.

3. A system in accordance with claim 2 wherein said control system is further configured to compare the set of normalized deviations to a predefined threshold.

4. A system in accordance with claim 2 wherein to calculate a characteristic value representative of the set of deviations said control system is further configured to divide the sum of the absolute values of the deviations from the set of deviations by (n−1), wherein n is the number of members in the set of means.

5. A system in accordance with claim 4 wherein to calculate a characteristic value representative of the set of deviations said control system is further configured to:
calculate the square root of the average of the absolute values of the set of deviations;
determine a difference between each of the set of mean values and the median; and
divide each of the determined differences by the square root of the average of the absolute values of the set of deviations.

6. A system in accordance with claim 2 wherein said control system is further configured to identify any normalized deviations exceeding a predefined threshold as being associated with anomalous behavior.

7. A system in accordance with claim 6 wherein the threshold is 1.5.

8. A system in accordance with claim 1 wherein said control system is further configured to cluster the data according to operating conditions under which the fleet of machines are operating during collection of the data.

9. A system in accordance with claim 1 wherein said control system is further configured to gather the data using a moving window defined by one of a predefined period of time and a predefined number of instances of sampling.

10. A system in accordance with claim 1 wherein the at least one operating characteristic is one of a mechanical characteristic; and an electrical characteristic of the machine being monitored.

11. A method for use in detecting anomalous behavior in at least one of a fleet of machines, wherein each of the machines includes at least one component in common with all other machines in the fleet, said method comprising:
coupling at least one of a plurality of sensors to each machine in the fleet, wherein each sensor is configured to: detect at least one operating characteristic of the at least one component; and transmit data representative of the detected characteristic to a control system; and
collecting data representative of the detected characteristic from each of the machines in the fleet, wherein the data is collected under similar operating conditions for each machine;
calculating a set of mean values from the detected characteristics of each of the machines in the fleet;
calculating a set of deviations corresponding to the set of mean values relative to a median value of the set of mean values; and
determining if anomalous behavior exists based on the set of deviations.

12. A method in accordance with claim 11 further comprising:
calculating a characteristic value representative of the set of deviations; and
calculating a set of normalized deviations for the calculated characteristic value for each of the machines in the fleet.

13. A method in accordance with claim 12 further comprising comparing the set of normalized deviations to a predefined threshold.

14. A method in accordance with claim 12 wherein calculating a characteristic value representative of the set of deviations further comprises dividing the sum of the absolute values of the deviations from the set of deviations by (n−1), wherein n is the number of members in the set of means.

15. A method in accordance with claim 14 wherein calculating a characteristic value representative of the set of deviations further comprises:
calculating the square root of the average of the absolute values of the set of deviations;
determining a difference between each of the set of mean values and the median; and
dividing each of the determined differences by the square root of the average of the absolute values of the set of deviations.

16. A method in accordance with claim 12 further comprising identifying any normalized deviations exceeding a predefined threshold as being associated with anomalous behavior.

17. A method in accordance with claim 16 wherein the threshold is 1.5.

18. A method in accordance with claim 11 further comprising clustering the data according to operating conditions under which the fleet of machines are operating during collection of the data.

19. A method in accordance with claim 11 further comprising gathering the data using a moving window defined by one of a predefined period of time and a predefined number of instances of sampling.

20. A method in accordance with claim 11 wherein the at least one operating characteristic is one of a mechanical characteristic; and an electrical characteristic of the machine being monitored.
